(19) United States
(12) Patent Application Publication
(10) Pub. No.: US 2003/0032400 A1
(43) Pub. Date: Feb. 13, 2003

(54) Dynamically programmable frequency scanning radio receiver and method of programming the same

(76) Inventors: Arthur Yuichi Tsubaki, Grapevine, TX (US); Kenneth Scott Carpenter, Rowlett, TX (US); James Francis Cassidy, Arlington, TX (US)

Correspondence Address: Lawrence R. Youst, Smith, Danamraj & Youst, P.C., Suite 1200, LB 15, 12900 Preston Road, Dallas, TX, 75230-1328, US

(21) Appl. No.: 09/924,788

(22) Filed: Aug. 8, 2001

(51) Int. Cl. H04B 1/18

(52) U.S. Cl. 455/186.1; 455/161.2; 455/185.1

(57) ABSTRACT

A dynamically programmable frequency scanning radio receiver (30) is disclosed. The frequency scanning radio receiver (30) includes a compiler circuit (38) that identifies transmitting parties of interest from the plurality of transmitting parties stored in a frequency database (42). The compiler circuit (38) identifies the transmitting parties of interest based upon the location of the receiver (32) that is determined by a position locator circuit (44). Frequency data corresponding to the transmitting parties of interest is then stored in a memory (40) such that a processing circuit (36) can be used to control the receiver (32) to monitor transmissions at the frequencies of the transmitting parties of interest. When the frequency scanning radio receiver (30) is moved to a geographical area having different transmitting parties of interest, the frequency scanning radio receiver (30) may be dynamically reprogrammed based upon the new location.

### TECHNICAL FIELD OF THE INVENTION

The present invention relates, in general, to frequency scanning radio receivers and, in particular, to a dynamically programmable frequency scanning radio receiver that is programmed with a set of operating frequencies to be scanned by the frequency scanning radio receiver based upon the location of the frequency scanning radio receiver.

### BACKGROUND OF THE INVENTION

Without limiting the scope of the present invention, its background is described with reference to programming a frequency scanning radio receiver, as an example.

Frequency scanning radio receivers are used to monitor radio transmissions within a given geographical area by continually tuning the receiver through a plurality of discrete frequencies. During this scanning process, when a transmission is detected on one of the frequencies being scanned, the receiver stops scanning such that the transmission may be monitored. Even though frequency scanning radio receivers can only monitor radio transmissions within a given geographical area, there are numerous transmitting parties assigned to the discrete frequencies within a given geographical area that are of interest to listeners. For example, usage types of general interest include police frequencies, airport frequencies, emergency medical service frequencies, fire department frequencies, public service agency frequencies, local business frequencies and the like.

Typically, the listener of a frequency scanning radio receiver wishes to program their frequency scanning radio receiver to scan only the frequencies of radio transmissions within the geographical area of the listener. In fact, the listeners commonly desire to program their frequency scanning radio receiver to scan only a subset of those frequencies which are of particular interest to that listener. Conventional frequency scanning radio receivers are manually programmed by the listener. Specifically, the listener must manually input the frequencies to be scanned using a keypad or similar input device. It has been found, however, that manually programming a frequency scanning radio receiver is difficult and time consuming, requiring many listeners to consult their owner's manual. In addition, each time the frequency scanning radio receiver is moved to a new geographic area, it must be reprogrammed.

Accordingly, prior art attempts have been made to automate the programming process. One such prior art system is disclosed in U.S. Pat. No. 6,192,223. In this system, the frequency scanning radio receiver is placed in communication with a remote host system in order to obtain frequency data of transmitting parties proximate the geographical location of the frequency scanning radio receiver. The connection to the remote host system is typically accomplished through a telephone network using a modem and dialing a 900 number. Alternatively, the connection to the remote host system could be accomplished using an acoustical modem and a telephone handset, using a wireless network such as a pager network or using the Internet via a direct connection to a computer or an external modem.

Once the connection to the remote host system is established, the remote host system requests geographical information regarding the location of the frequency scanning radio receiver, which is manually input by the listener in the form of a postal code, an area code or other geographic location designation identifier. The host system then compiles the frequency data from its database for the requested geographical area and returns frequency data to the frequency scanning radio receiver. The frequency data is then automatically stored in the memory of the frequency scanning radio receiver such that the frequency scanning radio receiver may now scan the operating frequencies of transmitting parties proximate the geographical location of the frequency scanning radio receiver.

It has been found, however, that this system of automatically programming a frequency scanning radio receiver remains inconvenient for the listener. Specifically, a very limited number of frequencies are supplied from the host system to the frequency scanning radio receiver, which correspond to only the transmitting parties proximate the geographical area provided by the listener. Thus, each time the listener travels outside of that geographical area, the listener must reestablish the communication with the remote host in order to update the frequency data to obtain the operating frequencies in the new geographical area. Similarly, as the operating frequencies of transmitting parties periodically change, new transmitting parties begin transmitting and old transmitting parties cease transmitting, the listener must again reestablish communication with the remote host in order to update the frequency data stored in frequency scanning radio receiver.

Therefore a need has arisen for a frequency scanning radio receiver that does not have to communicate with a remote host system to update the frequency data each time the listener moves from one geographic area to the next or each time operating frequencies within a geographical area change. A need has also arisen for such a frequency scanning radio receiver that is capable of dynamically programming the set of operating frequencies to be scanned by the frequency scanning radio receiver based upon the current operating frequencies being used in the location of the frequency scanning radio receiver. Further, a need has arisen for a method of dynamically programming the set of operating frequencies to be scanned into the memory of the frequency scanning radio receiver based upon the location of the frequency scanning radio receiver.

### SUMMARY OF THE INVENTION

The present invention disclosed herein comprises a frequency scanning radio receiver that does not have to communicate with a remote host system to update the frequency data each time the listener moves from one geographic area to the next or each time operating frequencies change. The frequency scanning radio receiver of the present invention is capable of being dynamically programmed with a set of operating frequencies to be scanned by the frequency scanning radio receiver based upon the location of the frequency scanning radio receiver. This is achieved using a method of the present invention for dynamically programming the set of operating frequencies to be scanned into the memory of the frequency scanning radio receiver.

The frequency scanning radio receiver of the present invention comprises a receiver that receives radio frequency transmissions at a plurality of discrete frequencies and a database of frequency data that includes operating frequencies and geographic locations of a plurality of transmitting parties. The frequency database may be internal to the frequency scanning radio receiver, removably insertable into the frequency scanning radio receiver or may be in local communication with the frequency scanning radio receiver. The local communication may be achieved via short range wireless communication such as infrared communication or short range radio communication. Alternatively, local communication may be achieved via a data cable.

The frequency scanning radio receiver also comprises a compiler circuit that identifies transmitting parties of interest from the plurality of transmitting parties based upon the location of the receiver, a memory that stores frequency data corresponding to the transmitting parties of interest and a position locator circuit that identifies the location of the receiver. The position locator circuit may be GPS based, cellular network based or may require manual input of location information. The position locator circuit may be internal to the frequency scanning radio receiver or may be in local communication with the frequency scanning radio receiver.

The frequency scanning radio receiver is controlled by a processing circuit, such as a microprocessor, that is coupled to the receiver, the database, the position locator circuit, the compiler circuit and the memory. The processor circuit provides the location of the receiver to the compiler circuit, stores the frequency data in the memory and controls the receiver to monitor transmissions at the frequencies of the transmitting parties of interest.

The frequency scanning radio receiver may be dynamically programmed by maintaining a non remote database of frequency data of a plurality of transmitting parties, identifying the location of the frequency scanning radio receiver, compiling frequency data for the transmitting parties of interest selected from the plurality of transmitting parties and based upon the location of the frequency scanning radio receiver, programming the frequency scanning radio receiver to monitor transmissions at the frequencies of the transmitting parties of interest, moving the frequency scanning radio receiver to a different location having different transmitting parties of interest and dynamically reprogramming the frequency scanning radio receiver to monitor transmissions at the frequencies of the different transmitting parties of interest by identifying the different location of the frequency scanning radio receiver and compiling frequency data for the different transmitting parties of interest selected from the plurality of transmitting parties based upon the different location of the frequency scanning radio receiver.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 is a schematic illustration of a dynamically programable frequency scanning radio receiver of the present invention;

FIG. 2 is a block diagram of a dynamically programable frequency scanning radio receiver of the present invention;

FIG. 3 is flow chart illustrating a method of programming a dynamically programable frequency scanning radio receiver of the present invention;

FIG. 4 is a block diagram of a dynamically programable frequency scanning radio receiver of the present invention in communication with a position locating device;

FIG. 5 is flow chart illustrating a method of programming a dynamically programable frequency scanning radio receiver of the present invention that communicates with a position locating device;

FIG. 6 is a block diagram of a dynamically programable frequency scanning radio receiver of the present invention in communication with a computing device;

FIG. 7 is flow chart illustrating a method of programming a dynamically programable frequency scanning radio receiver of the present invention that communicates with a computing device;

FIG. 8 is a block diagram of a dynamically programable frequency scanning radio receiver of the present invention in communication with a position locating device and a computing device;

FIG. 9 is flow chart illustrating a method of programming a dynamically programable frequency scanning radio receiver of the present invention that communicates with a position locating device and a computing device;

FIG. 10 is a block diagram of a dynamically programable frequency scanning radio receiver of the present invention in communication with a computing device; and

FIG. 11 is flow chart illustrating a method of programming a dynamically programable frequency scanning radio receiver of the present invention that communicates with a computing device.

### DETAILED DESCRIPTION OF THE INVENTION

While the making and using of various embodiments of the present invention are discussed in detail below, it should be appreciated that the present invention provides many applicable inventive concepts which can be embodied in a wide variety of specific contexts. The specific embodiments discussed herein are merely illustrative of specific ways to make and use the invention, and do not delimit the scope of the present invention.

Referring to FIG. 1, therein is depicted a schematic illustration of a frequency scanning radio receiver that is generally designated 10. Frequency scanning radio receiver 10 is used to monitor radio transmissions within a given geographical area by continually scanning through a plurality of discrete frequencies. During this scanning process, when a transmission is detected on one of the frequencies being scanned, frequency scanning radio receiver 10 stops scanning and monitors the transmission. Frequency scanning radio receiver 10 includes a display 12 that displays identification data corresponding to the transmitting party of the transmission being monitored by frequency scanning radio receiver 10. The identification data may include information such as the frequency of the transmission, in this case 470.5375 MHz, the name of the transmitting party, in this case, the Dallas Vice Unit, and the usage type of the transmission, in this case, Law Enforcement. Display 12 may be any suitable type of display including, but not limited to, a liquid crystal display, a light emitting diode display, a graphics display, such as an SVGA display, or the like.

Frequency scanning radio receiver 10 includes a plurality of data input members that are pictured as numerical key pad 14. It should be noted that key pad 14 may additionally be used to preform functions other than simple numeric data input such as alphanumeric data input, selection of banks, selection of priority channels and the like. Frequency scanning radio receiver 10 also includes a plurality of function input members 16 which are used to instruct frequency scanning radio receiver 10 to perform numerous functions such as scan, search and hold. Importantly, frequency scanning radio receiver 10 of the present invention includes a program button 18 that may be used by a listener to prompt frequency scanning radio receiver 10 to program itself. In addition, program button 18 may be use to place frequency scanning radio receiver 10 in dynamic program mode as will be discussed in greater detail below.

In the illustrated embodiment, frequency scanning radio receiver 10 has an antenna 20 which is used to receive radio frequency transmissions and in some embodiment of the present invention may be used to send and receive short distance radio frequency communications. Alternatively, a second antenna (not pictured) may be used to send and receive short distance radio frequency communications. Frequency scanning radio receiver 10 also includes a pair of control knobs 22, 24 which are used to turn frequency scanning radio receiver 10 on and off, adjust the volume of frequency scanning radio receiver 10, adjust the squelch of frequency scanning radio receiver 10 and the like.

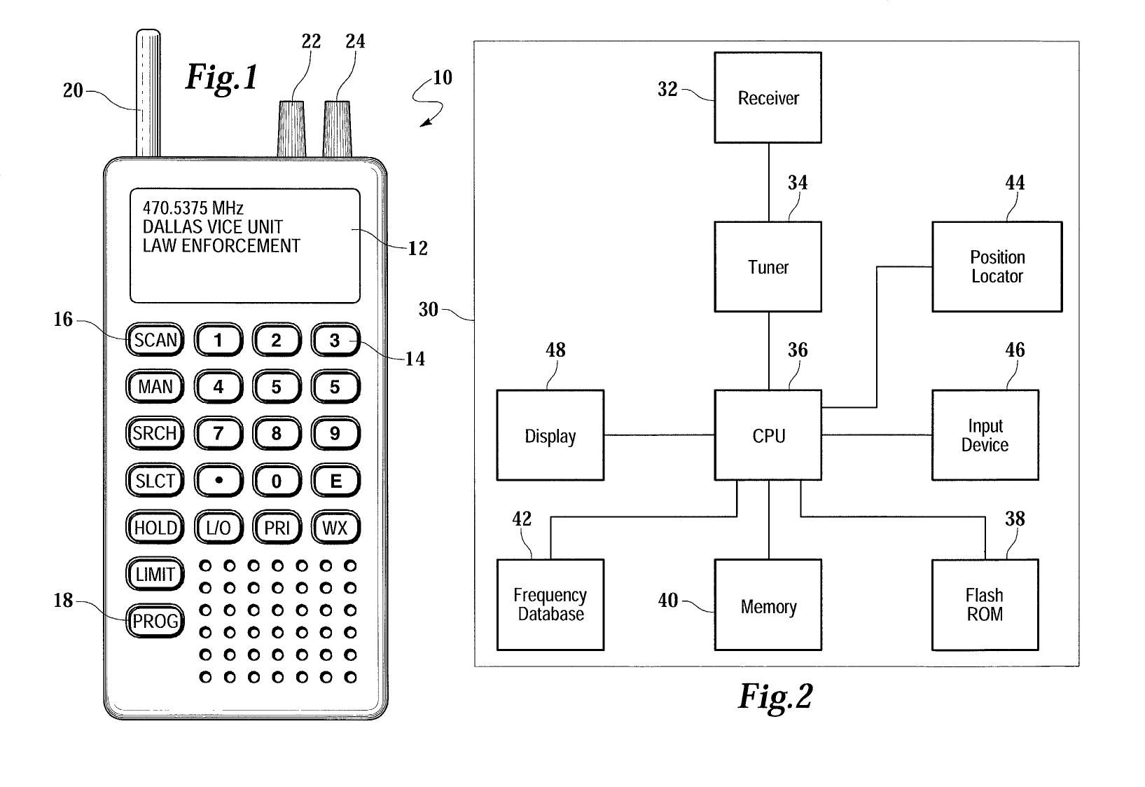

Referring now to FIG. 2, therein is depicted a block diagram of the components of a frequency scanning radio receiver of the present invention that is generally designated 30. Frequency scanning radio receiver 30 includes a receiver 32 that is coupled to antenna 20 (see FIG. 1) for receiving radio transmissions from the various transmitting parties. A tuner 34 is coupled to receiver 32. Tuner 34 may be used to search the entire range of radio frequencies that may be monitored by frequency scanning radio receiver 30 but is preferably used to scan the specific radio frequencies programmed into frequency scanning radio receiver 30.

A central processing unit 36, such as a microprocessor, is coupled to tuner 34 and is used to control the frequencies that are monitored by frequency scanning radio receiver 30. In the illustrated embodiment, central processing unit 36 executes a program stored in a memory 38, such as a flash ROM, that searches for frequency data stored in a memory 40 to determine whether tuner 34 should stop scanning when a transmission is detected at a particular frequency by receiver 32. Specifically, if the frequency of the detected transmission has been programmed into memory 40, then central processing unit 36 will instruct tuner 34 to stop scanning when such a transmission is detected by receiver 32. If, on the other hand, the frequency of the detected transmission has not been programmed into memory 40, then central processing unit 36 will instruct tuner 34 to continue scanning.

The frequency data is programmed into memory 40 from a frequency database 42 that stores frequency data relating to transmitting parties that transmit on various frequencies in various geographical areas. Frequency database 42 includes information such as the transmission location and frequency allocation of the plurality of transmitting parties. Frequency database 42 may be a single internal database or may comprise a plurality of internal databases. Alternatively, frequency database 42 may be stored on removable memory devices such as a removable memory card, a compact disk (CD), a digital versatile disk (DVD), a removable hard drive or the like. In either case, frequency database 42 may contain frequency data relating to substantially all of the frequency allocations in a large geographical region, such as a state, a region of a country, an entire county or continent and the like. Importantly, frequency database 42 may contain frequency data for a region significantly larger than the geographical area from which frequency scanning radio receiver 30 can monitor transmissions at any one time.

Alternatively, frequency database 42 may contain only a subset of the transmitting parties within a large geographical region. For example, an internal portion of frequency database 42 may contain transmitting parties having particular usage types such as police frequencies, airport frequencies, emergency medical service frequencies, fire department frequencies, public service agency frequencies, local business frequencies or combinations thereof. In addition, a removable memory portion of frequency database 42 may be used to add frequencies of addition usage types such as NASCAR frequencies, mariner frequencies, ham frequencies and the like.

As frequency allocations and transmitting parties periodically change, frequency database 42 may need to be periodically updated. In the case where frequency database 42 is stored on removable memory devices, new removable memory devices containing updated frequency data may be obtained. Alternatively, updated frequency data may be downloaded from various locations, such as via the Internet, and stored in frequency database 42 regardless of whether frequency database 42 is internal, removable or both. Importantly, using the present invention, it is not necessary to provide the geographical location of frequency scanning radio receiver 30 when updating frequency database 42 as the frequency data being downloaded is for a geographical area much larger than the area from which transmissions may be monitored by frequency scanning radio receiver 30 at any one time.

The frequency data obtained from frequency database 42, based upon the location of frequency scanning radio receiver 30, is then programed into memory 40. The location of frequency scanning radio receiver 30 is determined by position locator circuit 44. In one embodiment of the present invention, position locator circuit 44 includes a global positioning system receiver that receives transmissions from, for example, satellites in a global positioning system (GPS) The satellite positions are used by position locator circuit 44 as precise reference points to determine the location of frequency scanning radio receiver 30. When receiving the signals from at least four satellites, the position of frequency scanning radio receiver 30 can be determined based upon latitude, longitude, altitude and time. Central processing unit 36 is used to process the GPS data such that the position of the frequency scanning radio receiver 30 can be used in identifying transmitting parties of interest.

Alternatively, position locator circuit 44 may include an analog or digital cellular transceiver that communicates with a plurality of cellular base stations, for example, at least three cellular base stations. The positions of the base stations relative to frequency scanning radio receiver 30 are used by position locator circuit 44 as precise reference points to determine the location of frequency scanning radio receiver 30. When communicating with at least three base stations, the position of frequency scanning radio receiver 30 can be determined based upon latitude and longitude. Central processing unit 36 processes the location information such that the position of the frequency scanning radio receiver 30 can be used to identify transmitting parties of interest.

As yet another alternative, position locator circuit 44 may receive user input from input device 46, which may be a keypad or other suitable device. The listener may input location information such as zip code, area code, city, county or other suitable indicia of location. Central processing unit 36 processes this location information such that frequency scanning radio receiver 30 can be programmed.

Once the location of frequency scanning radio receiver 30 has been determined, this information is used to identify which transmitting parties stored in frequency database 42 can presently be monitored by frequency scanning radio receiver 30. The frequencies that can be monitored as well as information regarding the transmitting parties are programmed into memory 40 by central processing unit 36. Thereafter, frequency scanning radio receiver 30 can scan the frequencies programmed into memory 40 to monitor transmission made by the transmitting parties at those frequencies. These frequencies may be programmed into particular banks or particular channels based upon usage type or other listener preference. In addition, information about the transmitting parties being monitored can be presented to the listener of frequency scanning radio receiver 30 via a display in a format such as that depicted in FIG. 1 or other suitable format.

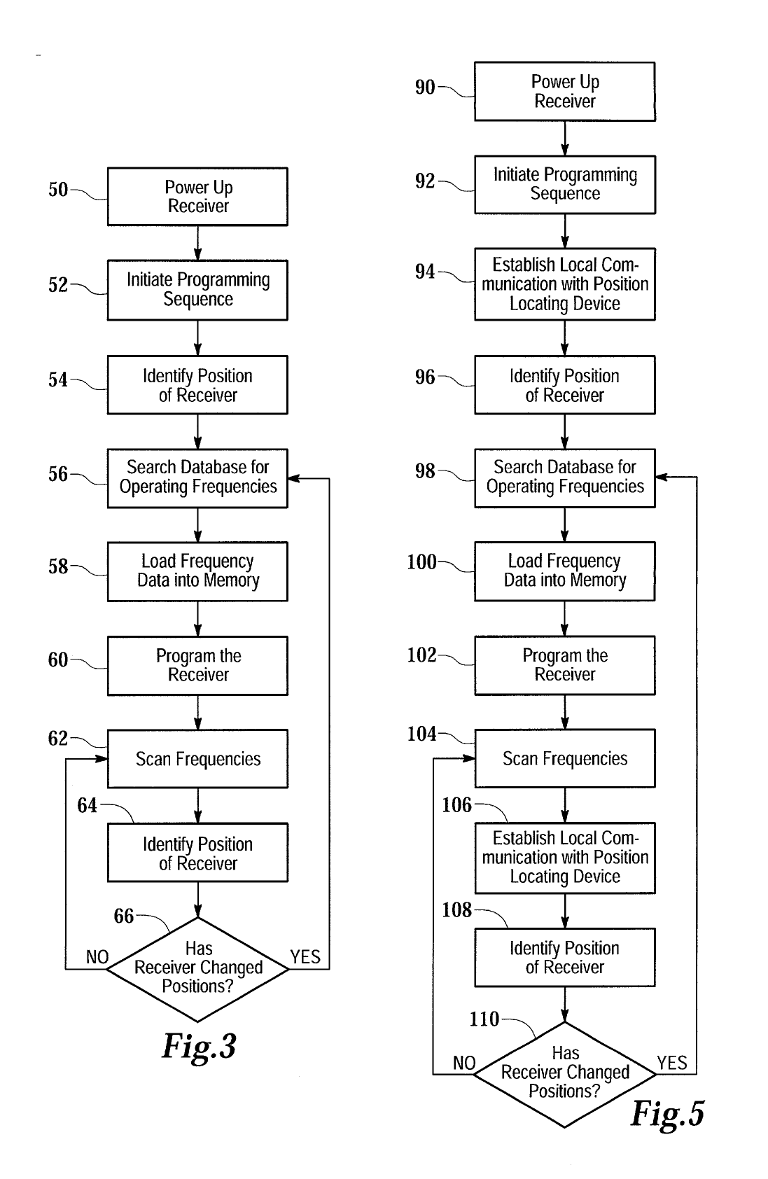

Referring now to FIG. 3, therein is depicted a flow chart illustrating a method of dynamically programming a frequency scanning radio receiver of the present invention such as frequency scanning radio receiver 30 depicted in FIG. 2. When the listener powers up frequency scanning radio receiver 30, in step 50, using, for example, control knob 22, the listener simply presses program key 18, in step 52, to initiate the programming of frequency scanning radio receiver 30. Pressing program key 18 causes central processing unit 36 to execute a program stored in memory 38 that programs frequency scanning radio receiver 30 to monitor radio transmissions from transmitting parties within the geographical area of frequency scanning radio receiver 30. More specifically, central processing unit 36 instructs position locator 44 to identify the location of frequency scanning radio receiver 30, in step 54. This may be accomplished in an automated manner in those embodiments having, for example, position locators that are GPS based or cellular network based, as described above or this may be accomplished manually in those embodiments wherein a geographic code is inputted by the listener via input device 46, also as described above.

Once the position of frequency scanning radio receiver 30 is identified, the frequency scanning radio receiver programming program searches frequency database 42 for transmitting parties in the identified geographical area, in step 56. Once these transmitting parties of interest are compiled, frequency data relating to the transmitting parties of interest is loaded into memory 40, in step 58. Using the frequency data, central processing unit 36 programs frequency scanning radio receiver 30, in step 60, such that the frequencies of the transmitting parties of interest may be monitored, in step 62.

One unique feature of frequency scanning radio receiver 30 of the present invention is that the listener may place frequency scanning radio receiver 30 in dynamic programming mode wherein position locator 44 will periodically determine whether frequency scanning radio receiver 30 has changed locations. This feature is particularly advantageous when frequency scanning radio receiver 30 is used within a moving vehicle such as an automobile, a tractor-trailer unit or a passenger rail car. To determine whether frequency scanning radio receiver 30 has changed locations, position locator circuit 44 identifies the position of frequency scanning radio receiver 30 in step 64. If, in decision 66, it is determined that the location of frequency scanning radio receiver 30 has not changed or is within a predetermined distance from its originally determined position, frequency scanning radio receiver 30 continues to monitor the frequencies of the original transmitting parties of interest. If, on the other hand, it is determined in decision 66 that the location of frequency scanning radio receiver 30 has changed or is no longer within a predetermined distance from its original position, then the new location of frequency scanning radio receiver 30 is used to search for new transmitting parties of interest from frequency database 42 in step 56, frequency data relating to the new transmitting parties of interest is loaded into memory 40 in step 58, frequency scanning radio receiver 30 is programmed to monitor the frequencies of the new transmitting parties of interest in step 60 and frequency scanning radio receiver 30 scans the frequencies of the new transmitting parties for transmissions, in step 62.

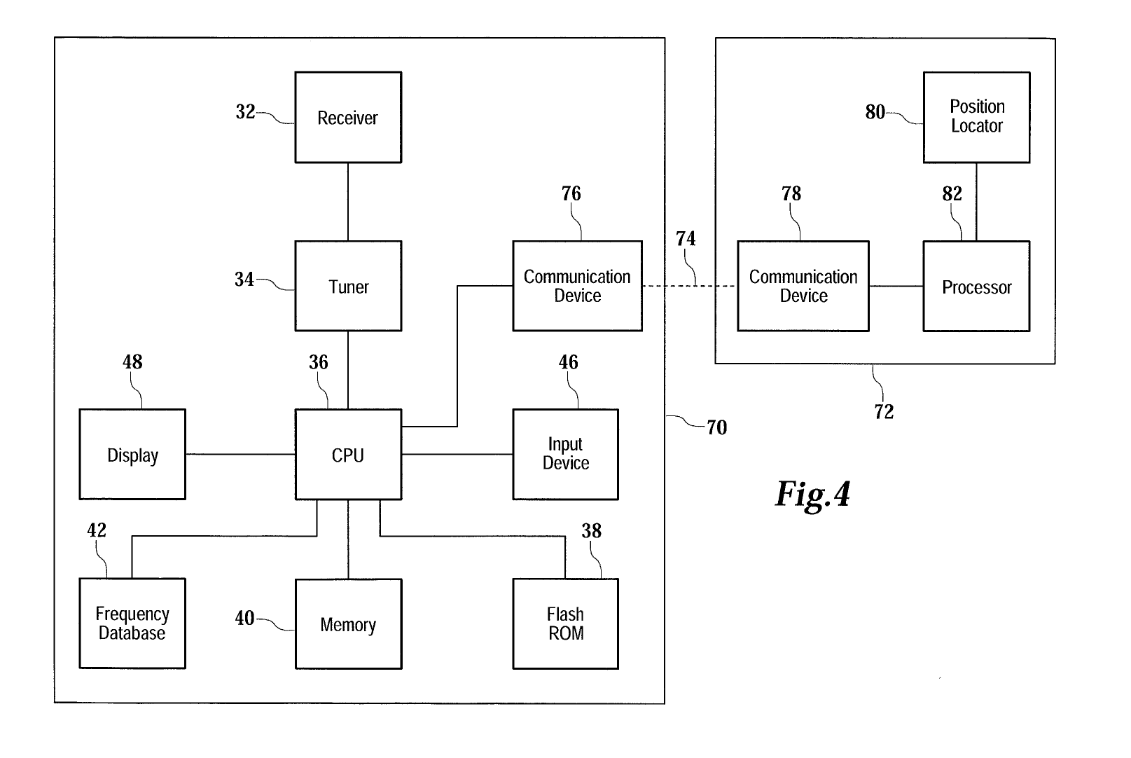

Referring now to FIG. 4, therein is depicted a block diagram of the components of a frequency scanning radio receiver of the present invention that is generally designated 70. Frequency scanning radio receiver 70 includes a receiver 32 that is coupled to the antenna (not pictured) for receiving radio transmissions from the various transmitting parties. A tuner 34 is coupled to receiver 32. A central processing unit 36, such as a microprocessor, is coupled to tuner 34 and is used to control the frequencies that are monitored by frequency scanning radio receiver 70. In the illustrated embodiment, a central processing unit 36 executes a program stored in a memory 38, such as a flash ROM, that searches for frequency data stored in a memory 40 to determine which frequencies should be scanned by tuner 34.

The frequency data is programmed into memory 40 from a frequency database 42 that stores frequency data relating to a plurality of transmitting parties in various geographical areas. The frequency data is programmed into memory 40 based upon the location of frequency scanning radio receiver 70. In the illustrated embodiment, the location of frequency scanning radio receiver 70 is determined by position locating device 72 that is in local communication with frequency scanning radio receiver 70. Position locating device 72 may, for example, be a GPS receiver, a cellular telephone or other suitable device capable of position determination.

In the illustrated embodiment, a communication link 74 between position locating device 72 and frequency scanning radio receiver 70 may be established using a communication device 76 of frequency scanning radio receiver 70 and a communication device 78 of position locating device 72. Communication devices 76, 78 may communicate with one another via short distance wireless communications such as via infrared communications, radio frequency communications, including Bluetooth communications, or other suitable technique. Alternatively, communication devices 76, 78 may communicate with one another via a data cable or other direct connection.

In the illustrated embodiment, position locating device 72 includes a position locator 80 such as a GPS receiver or a cellular network transceiver. In addition, position locating device 72 includes a processor 82, such as a microprocessor, that is used to control the operation of communication device 78 and position locator 80.

The process of dynamically programming frequency scanning radio receiver 70 is described with reference to FIG. 5. After the listener powers up frequency scanning radio receiver 70, in step 90, the listener presses program key 18, in step 92, to initiate the programming of frequency scanning radio receiver 70. Pressing program key 18 causes central processing unit 36 to execute a program stored in memory 38 that programs frequency scanning radio receiver 70.

More specifically, central processing unit 36 instructs communication device 76 to establish communication link 74 with communication device 78 of position locating device 72 in step 94. Once communication is established, a request for position identification is sent from frequency scanning radio receiver 70 via communication link 74 to position locating device 72. Position locating device 72 responds by determining its position and returning this information to frequency scanning radio receiver 70 via communication link 74 in step 96.

Once the position of frequency scanning radio receiver 70 is identified, central processing unit 36 instructs the frequency scanning radio receiver programming program to search frequency database 42 for transmitting parties in the identified geographical area, in step 98. Once these transmitting parties of interest are compiled, frequency data relating to the transmitting parties of interest is loaded into memory 40, in step 100. Using the frequency data, central processing unit 36 programs frequency scanning radio receiver 70, in step 102, such that the frequencies of the transmitting parties of interest may be monitored, in step 104.

The transmitting parties of interest may be dynamically updated using frequency scanning radio receiver 70. In this case, communication is reestablished via communication link 74 and a new request for position identification is sent from frequency scanning radio receiver 70 to position locating device 72 in step 106. Position locating device 72 responds by determining its position and returning this information to frequency scanning radio receiver 70 via communication link 74 in step 108. If it is determined that the position of frequency scanning radio receiver 70 has not significantly changed in decision 110, frequency scanning radio receiver 70 continues to monitor the frequencies of the original transmitting parties of interest. If, on the other hand, it is determined in decision 110 that the location of frequency scanning radio receiver 70 has significantly changed, then frequency database 42 is searched for new transmitting parties of interest in step 98, frequency data relating to the new transmitting parties of interest is loaded into memory 40 in step 100, frequency scanning radio receiver 70 is programmed to monitor the frequencies of the new transmitting parties of interest in step 102 and frequency scanning radio receiver 70 scans the frequencies of the new transmitting parties for transmissions, in step 104.

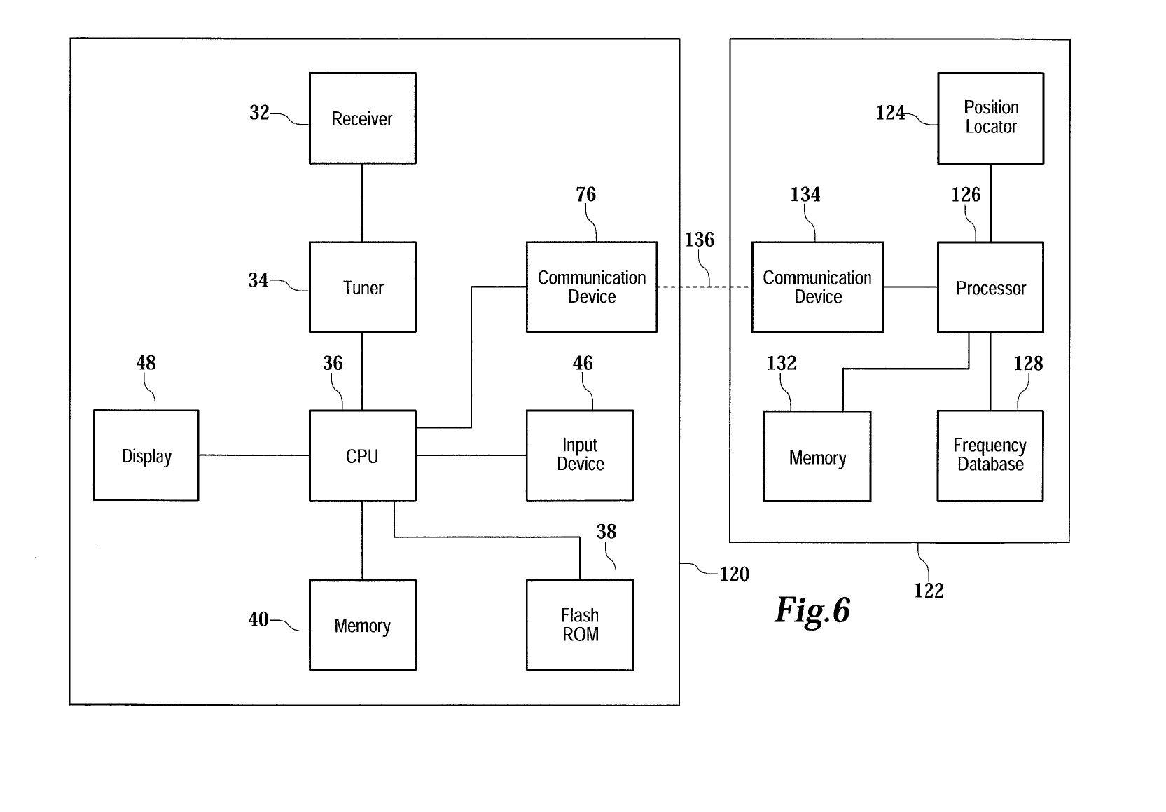

Referring now to FIG. 6, therein is depicted a block diagram of the components of a frequency scanning radio receiver of the present invention that is generally designated 120. Frequency scanning radio receiver 120 includes receiver 32, tuner 34 and central processing unit 36. In the illustrated embodiment, central processing unit 36 executes a program stored in a memory 38 that initiates the process of programming frequency scanning radio receiver 120. This is achieved by establishing communication between frequency scanning radio receiver 120 and computing device 122 which may be a portable computer, a personal computer, a personal digital assistant or the like. Computing device 122 includes a position locator 124 such as a GPS receiver, a cellular transceiver or the like, a processor 126, such as a microprocessor, a frequency database 128, a memory 132 and a communication device 134. To communicate, a communication link 136 is established between communication devices 76, 134, for example, via short distance wireless communications, via a data cable or other suitable means.

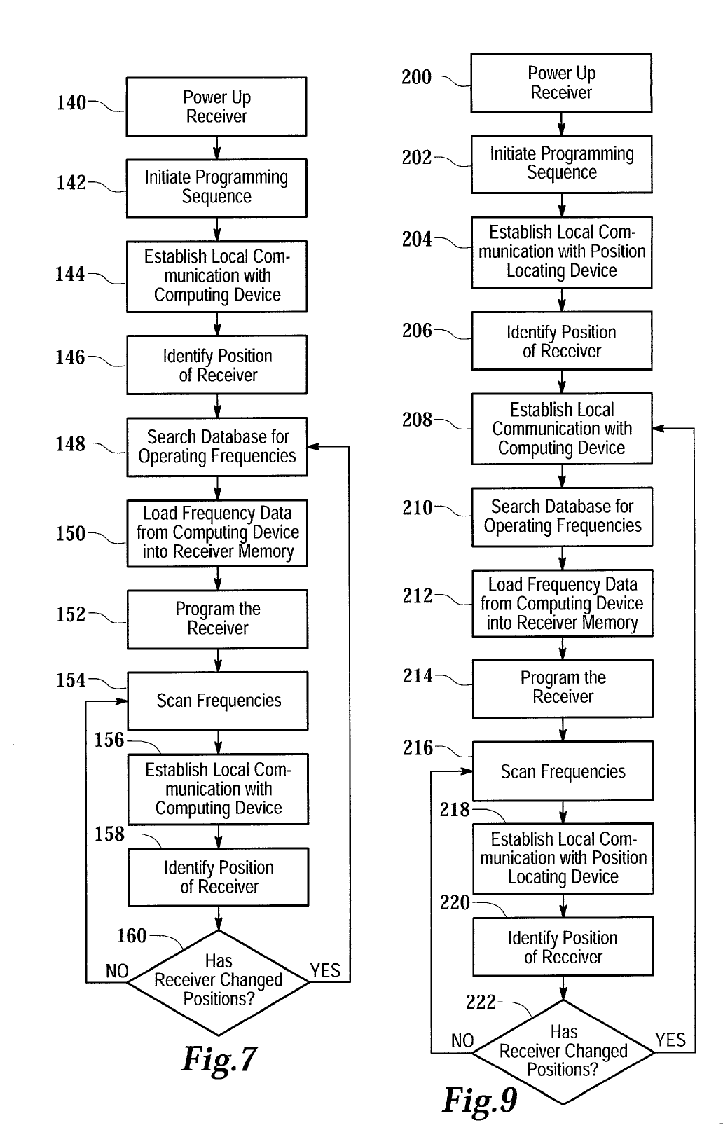

The process of dynamically programming frequency scanning radio receiver 120 is depicted in FIG. 7. After the listener powers up frequency scanning radio receiver 120, in step 140, the listener presses program key 18, in step 142, to initiate the programming process. This causes central processing unit 36 to instruct communication device 76 to establish communication link 136 with communication device 134 of computing device 122 in step 144. Once communication is established, a request for frequency data for transmitting parties of interest is sent from frequency scanning radio receiver 120 via communication link 136 to computing device 122. Computing device 122 then determines its position using position locator 124 in step 146. Processor 126 execute a program to search frequency database 128 for transmitting parties in the identified geographical area, in step 148. Once the set of transmitting parties of interest is compiled, frequency data relating to the transmitting parties of interest is temporarily stored in memory 132 and is then transferred to frequency scanning radio receiver 120 via communication link 136 where it is loaded into memory 40 in step 150. Using the frequency data, central processing unit 36 programs frequency scanning radio receiver 120, in step 152, such that the frequencies of the transmitting parties of interest may be monitored, in step 154.

The transmitting parties of interest may be dynamically updated in frequency scanning radio receiver 120 if it is placed in dynamic programming mode. In this case, communication is reestablished via communication link 136 and a new request for frequency data is sent from frequency scanning radio receiver 120 to computing device 122 in step 156. Computing device 122 then determines its position in step 158. If it is determined that the position of computing device 122 has not significantly changed in decision 160, this information is returned to frequency scanning radio receiver 120 via communication link 136 and frequency scanning radio receiver 120 continues to monitor the frequencies of the original transmitting parties of interest in step 154.

If, on the other hand, it is determined in decision 160 that the location of computing device 122 has significantly changed, then frequency database 128 is searched for new transmitting parties of interest in step 148, frequency data relating to the new transmitting parties of interest is temporarily stored in memory 132, then transferred to frequency scanning radio receiver 120 via communication link 136 and loaded into memory 40 in step 150, such that frequency scanning radio receiver 120 is programmed to monitor the frequencies of the new transmitting parties of interest in step 152 and frequency scanning radio receiver 120 scans the frequencies of the new transmitting parties of interest for transmissions, in step 154.

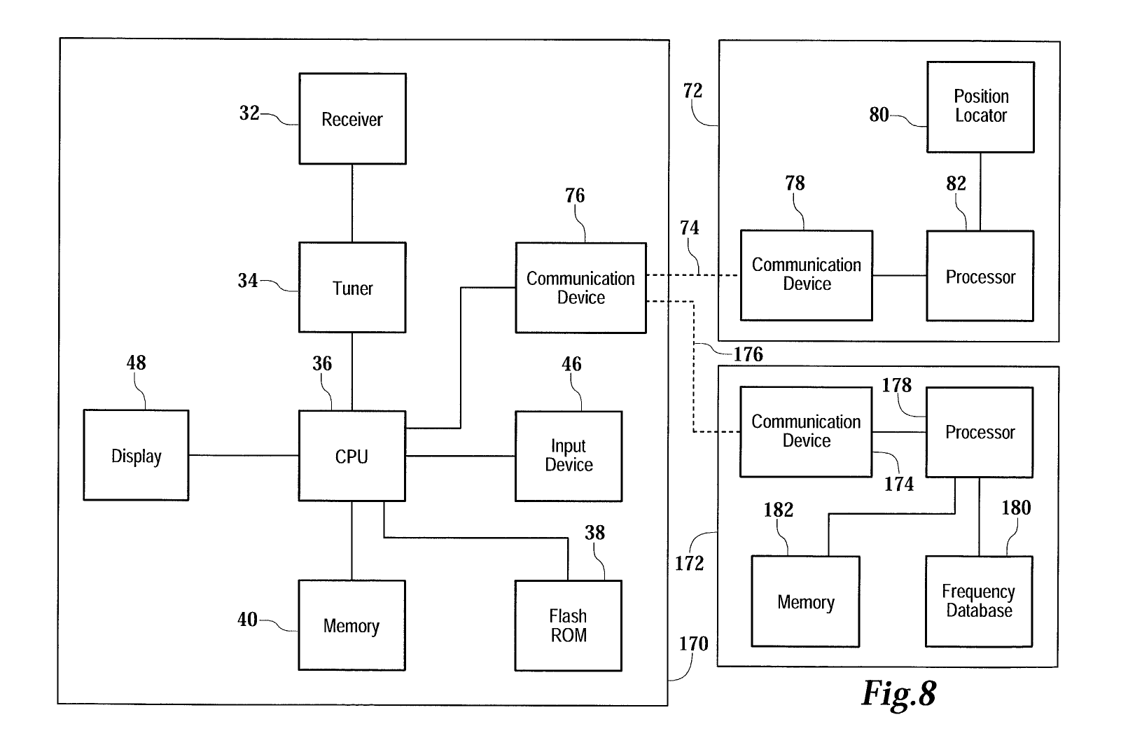

Referring next to FIGS. 8 and 9, the process of dynamically programming frequency scanning radio receiver 170 is described. After the listener powers up frequency scanning radio receiver 170, in step 200, the listener presses program key 18, in step 202, to initiate the programming process which causes central processing unit 36 to execute a program stored in memory 38.

More specifically, central processing unit 36 instructs communication device 76 to establish communication link 74 with communication device 78 of position locating device 72 in step 204. Once communication is established, a request for position identification is sent from frequency scanning radio receiver 170 via communication link 74 to position locating device 72. Position locating device 72 responds by determining its position and returning this information to frequency scanning radio receiver 170 via communication link 74 in step 206.

Once the position of frequency scanning radio receiver 170 is identified, central processing unit 36 instructs frequency scanning radio receiver 170 to communicate with computing device 172. This is achieved by establishing a communication link 176 between communication device 76 and communication device 174 in step 208. Once communication is established, a request for frequency data for transmitting parties of interest is sent from frequency scanning radio receiver 170 via communication link 176 to computing device 172. Processor 178 then executes a program to search frequency database 180 for transmitting parties in the identified geographical area, in step 216. Once these transmitting parties of interest are compiled, frequency data relating to the transmitting parties of interest is temporarily stored in memory 182, then transmitted to frequency scanning radio receiver 170 for storage in memory 40, in step 212. Using the frequency data, central processing unit 36 programs frequency scanning radio receiver 170, in step 214, such that the frequencies of the transmitting parties of interest may be monitored, in step 216.

The transmitting parties of interest may be dynamically updated using frequency scanning radio receiver 170 by reestablishing communication via communication link 74 and sending a new request for position identification from frequency scanning radio receiver 170 to position locating device 72 in step 218. Position locating device 72 responds by determining its position and returning this information to frequency scanning radio receiver 170 via communication link 74 in step 220. If it is determined that the position of frequency scanning radio receiver 170 has not significantly changed in decision 222, frequency scanning radio receiver 170 continues to monitor the frequencies of the original transmitting parties of interest. If, on the other hand, it is determined in decision 222 that the location of frequency scanning radio receiver 170 has significantly changed, communication with computing device 172 is reestablished in step 208, frequency database 180 is searched for new transmitting parties of interest in step 210, frequency data relating to the new transmitting parties of interest is transmitted to frequency scanning radio receiver 170 and is loaded into memory 40 in step 212, frequency scanning radio receiver 170 is programmed to monitor the frequencies of the new transmitting parties of interest in step 214 and frequency scanning radio receiver 170 scans the frequencies of the new transmitting parties of for transmissions, in step 216.

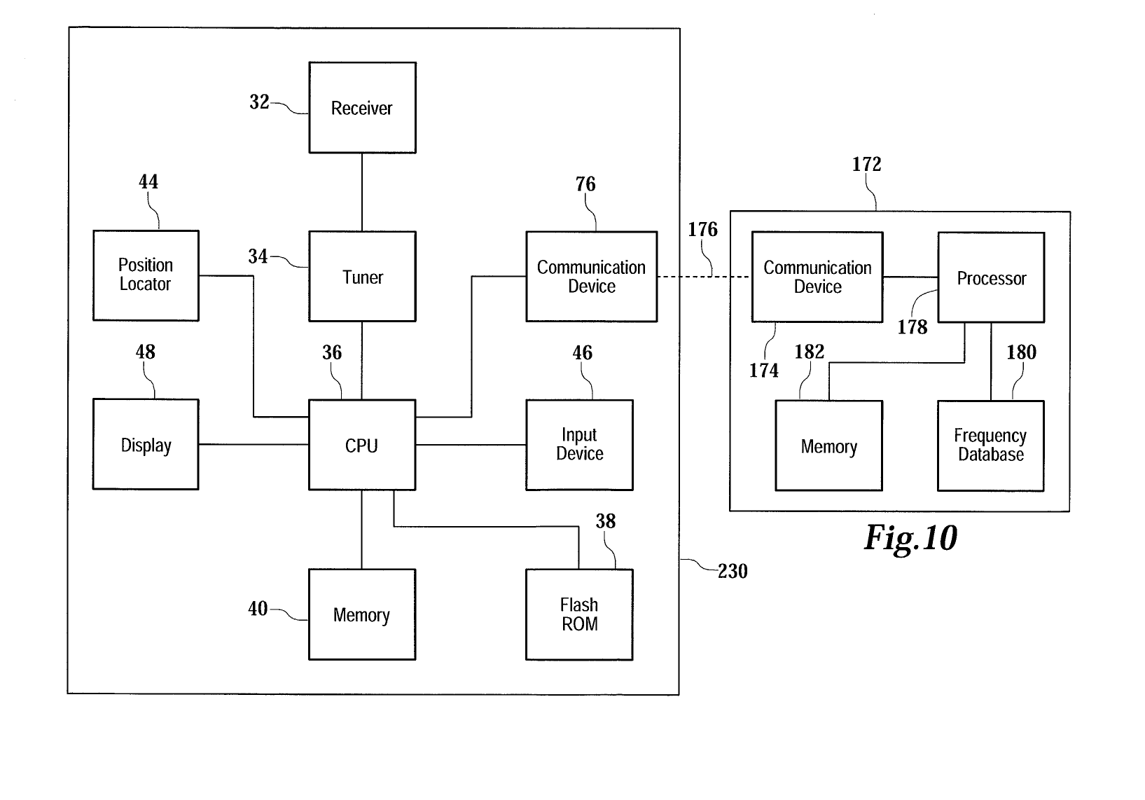

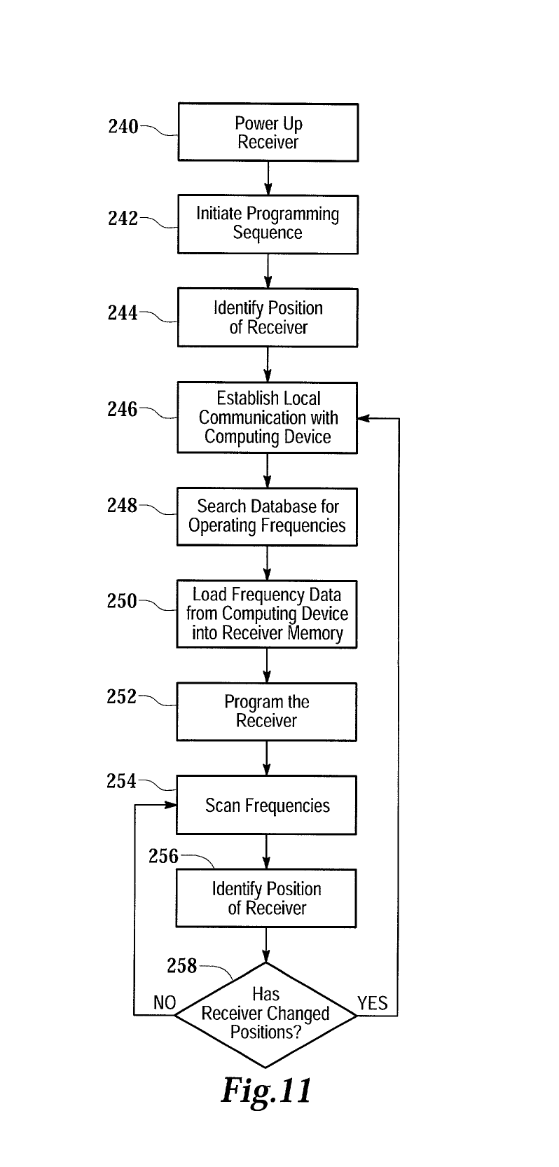

Referring next to FIGS. 10 and 11, the process of dynamically programming frequency scanning radio receiver 230 is described. After the listener powers up frequency scanning radio receiver 230, in step 240, the listener presses program key 18, in step 242, which causes central processing unit 36 to execute a program stored in memory 38. More specifically, central processing unit 36 instructs position locator 44 to determine the location of frequency scanning radio receiver 230 in step 244.

Once the position of frequency scanning radio receiver 230 is identified, central processing unit 36 instructs frequency scanning radio receiver 230 to communicate with computing device 172 via communicator link 176 between communication devices 76, 174, in step 246. Once communication is established, a request for frequency data for transmitting parties of interest is sent to computing device 172. Processor 178 then executes a program to search frequency database 180 for transmitting parties in the identified geographical area, in step 248. Once these transmitting parties of interest are compiled, frequency data relating to the transmitting parties of interest is temporarily stored in memory 182, then transmitted to frequency scanning radio receiver 230 for loading into memory 40, in step 250. Using the frequency data, central processing unit 36 programs frequency scanning radio receiver 230, in step 252, such that the frequencies of the transmitting parties of interest may be monitored, in step 254.

The transmitting parties of interest may be dynamically updated using frequency scanning radio receiver 230 by first determining the position of frequency scanning radio receiver 230 with position locator 44 in step 256. If it is determined that the position of frequency scanning radio receiver 230 has not significantly changed in decision 258, frequency scanning radio receiver 230 continues to monitor the frequencies of the original transmitting parties of interest. If, on the other hand, it is determined in decision 258 that the location of frequency scanning radio receiver 230 has significantly changed, then communication is reestablished with computing device 172 in step 246, frequency database 180 is searched for new transmitting parties of interest in step 248, frequency data relating to the new transmitting parties of interest is transmitted to frequency scanning radio receiver 230 and loaded into memory 40 in step 250, frequency scanning radio receiver 230 is programmed to monitor the frequencies of the new transmitting parties of interest in step 252 and frequency scanning radio receiver 230 scans the frequencies of the new transmitting parties for transmissions, in step 254.

As should be apparent to those skilled in the art, the frequency scanning radio receivers of the present invention have inherent advantages over the prior art. Specifically, the frequency scanning radio receivers of the present invention do not have to communicate with a remote host system to update the frequency data each time the listener moves from one geographic area to the next or each time operating frequencies change. Instead, the frequency scanning radio receivers of the present invention are capable of being dynamically programmed using information stored internally, removably or locally in a frequency database and using position information obtained from an internal or local position locator.

While this invention has been described with reference to illustrative embodiments, this description is not intended to be construed in a limiting sense. Various modifications and combinations of the illustrative embodiments as well as other embodiments of the invention, will be apparent to persons skilled in the art upon reference to the description. It is, therefore, intended that the appended claims encompass any such modifications or embodiments.

What is claimed is:

1. A programmable frequency scanning radio receiver comprising:
a receiver that receives radio frequency transmissions at a plurality of discrete frequencies;
a database of frequency data including operating frequencies and geographic locations of a plurality of transmitting parties;
a position locator circuit that identifies the location of the receiver;
a compiler circuit that identifies transmitting parties of interest from the plurality of transmitting parties based upon the location of the receiver;
a memory that stores frequency data corresponding to the transmitting parties of interest; and
a processing circuit coupled to the receiver, the database, the position locator circuit, the compiler circuit and the memory that provides the location of the receiver to the compiler circuit, stores the frequency data in the memory and controls the receiver to monitor transmissions at the frequencies of the transmitting parties of interest.

2. The programmable frequency scanning radio receiver as recited in claim 1 wherein the database of frequency data is stored within a second memory internal to the frequency scanning radio receiver.

3. The programmable frequency scanning radio receiver as recited in claim 1 wherein the database of frequency data is stored on a memory device that is removably insertable into the frequency scanning radio receiver.

4. The programmable frequency scanning radio receiver as recited in claim 1 wherein the database of frequency data further comprises frequency data relating to at least one usage type.

5. The programmable frequency scanning radio receiver as recited in claim 1 wherein the position locator circuit is a GPS based circuit.

6. The programmable frequency scanning radio receiver as recited in claim 1 wherein the position locator circuit is a cellular network based circuit.

7. The programmable frequency scanning radio receiver as recited in claim 1 further comprising an input device coupled to the processing circuit.

8. The programmable frequency scanning radio receiver as recited in claim 7 wherein the position locator circuit receives position information input into the input device.

9. The programmable frequency scanning radio receiver as recited in claim 1 further comprising a display coupled to the processing circuit that displays identification data relating to the transmitting parties of interest.

10. A programmable frequency scanning radio receiver comprising:
a receiver that receives radio frequency transmissions at a plurality of discrete frequencies;
a database of frequency data including operating frequencies and geographic locations of a plurality of transmitting parties;
a compiler circuit that identifies transmitting parties of interest from the plurality of transmitting parties based upon the location of the receiver;
a memory that stores frequency data corresponding to the transmitting parties of interest;
a communication device that communicates locally with a position locating device that identifies the location of the receiver; and
a processing circuit coupled to the receiver, the database, the communication device, the compiler circuit and the memory that provides the location of the receiver to the compiler circuit, stores the frequency data in the memory and controls the receiver to monitor transmissions at the frequencies of the transmitting parties of interest.

11. The programmable frequency scanning radio receiver as recited in claim 10 wherein the database of frequency data is stored within a second memory internal to the frequency scanning radio receiver.

12. The programmable frequency scanning radio receiver as recited in claim 10 wherein the database of frequency data is stored on a memory device that is removably insertable into the frequency scanning radio receiver.

13. The programmable frequency scanning radio receiver as recited in claim 10 wherein the database of frequency data further comprises frequency data relating to at least one usage type.

14. The programmable frequency scanning radio receiver as recited in claim 10 wherein the position locating device is GPS based.

15. The programmable frequency scanning radio receiver as recited in claim 10 wherein the position locating device is cellular network based.

16. The programmable frequency scanning radio receiver as recited in claim 10 further comprising an input device coupled to the processing circuit.

17. The programmable frequency scanning radio receiver as recited in claim 10 further comprising a display coupled to the processing circuit that displays identification data relating to the transmitting parties of interest.

18. The programmable frequency scanning radio receiver as recited in claim 10 wherein the communication device communicates via infrared communication.

19. The programmable frequency scanning radio receiver as recited in claim 10 wherein the communication device communicates via short range radio communication.

20. The programmable frequency scanning radio receiver as recited in claim 10 wherein the communication device is coupled to the position locating device via a data cable.

21. A programmable frequency scanning radio receiver comprising:
a receiver that receives radio frequency transmissions at a plurality of discrete frequencies;
a communication device that communicates locally with a computing device that includes a position locator that identifies the location of the receiver, a database of frequency data including operating frequencies and geographic locations of a plurality of transmitting parties and a compiler circuit that identifies transmitting parties of interest from the plurality of transmitting parties based upon the location of the receiver, the communication device receiving frequency data relating to the transmitting parties of interest;
a memory that stores frequency data corresponding to the transmitting parties of interest; and
a processing circuit coupled to the receiver, the communication device and the memory that stores frequency data in the memory and controls the receiver to monitor transmissions at the frequencies of the transmitting parties of interest.

22. The programmable frequency scanning radio receiver as recited in claim 21 wherein the position locator is GPS based.

23. The programmable frequency scanning radio receiver as recited in claim 21 wherein the position locator is cellular network based.

24. The programmable frequency scanning radio receiver as recited in claim 21 further comprising an input device coupled to the processing circuit.

25. The programmable frequency scanning radio receiver as recited in claim 21 further comprising a display coupled to the processing circuit that displays identification data relating to the transmitting parties of interest.

26. The programmable frequency scanning radio receiver as recited in claim 21 wherein the communication device communicates via infrared communication.

27. The programmable frequency scanning radio receiver as recited in claim 21 wherein the communication device communicates via short range radio communication.

28. The programmable frequency scanning radio receiver as recited in claim 21 wherein the communication device is coupled to the computing device via a data cable.

29. A programmable frequency scanning radio receiver comprising:
a receiver that receives radio frequency transmissions at a plurality of discrete frequencies;
a position locator circuit that identifies the location of the receiver;
a communication device that communicates locally with a computing device including a database of frequency data including operating frequencies and geographic locations of a plurality of transmitting parties and a compiler circuit that identifies transmitting parties of interest from the plurality of transmitting parties based upon the location of the receiver, the communication device transmitting the location information to the computing device and receiving frequency data relating to the transmitting parties of interest from the computing device;
a memory that stores frequency data corresponding to the transmitting parties of interest; and
a processing circuit coupled to the receiver, the position locator circuit, the communication device and the memory that stores the frequency data in the memory and controls the receiver to monitor transmissions at the frequencies of the transmitting parties of interest.

30. The programmable frequency scanning radio receiver as recited in claim 29 wherein the position locator circuit is GPS based.

31. The programmable frequency scanning radio receiver as recited in claim 29 wherein the position locator circuit is cellular network based.

32. The programmable frequency scanning radio receiver as recited in claim 29 further comprising an input device coupled to the processing circuit.

33. The programmable frequency scanning radio receiver as recited in claim 32 wherein the position locator circuit receives position information input into the input device.

34. The programmable frequency scanning radio receiver as recited in claim 29 further comprising a display coupled to the processing circuit that displays identification data relating to the transmitting parties of interest.

35. The programmable frequency scanning radio receiver as recited in claim 29 wherein the communication device communicates via infrared communication.

36. The programmable frequency scanning radio receiver as recited in claim 29 wherein the communication device communicates via short range radio communication.

37. The programmable frequency scanning radio receiver as recited in claim 29 wherein the communication device is coupled to the computing device via a data cable.

38. A method for programming a frequency scanning radio receiver to monitor frequencies of transmitting parties of interest comprising the steps of:
maintaining a non remote database of frequency data including operating frequencies and geographic locations of a plurality of transmitting parties;
identifying the location of the frequency scanning radio receiver;
compiling frequency data for the transmitting parties of interest selected from the plurality of transmitting parties based upon the location of the frequency scanning radio receiver; and
programming the frequency scanning radio receiver to monitor transmissions at the frequencies of the transmitting parties of interest.

39. The method as recited in claim 38 wherein the step of maintaining a non remote database of frequency data of a plurality of transmitting parties further comprises maintaining the non remote database of frequency data in a memory internal to the frequency scanning radio receiver.

40. The method as recited in claim 38 wherein the step of maintaining a non remote database of frequency data of a plurality of transmitting parties further comprises maintaining the non remote database of frequency data in a memory device that is removably insertable into the frequency scanning radio receiver.

41. The method as recited in claim 38 wherein the step of maintaining a non remote database of frequency data of a plurality of transmitting parties further comprises maintaining the non remote database of frequency data in a local device communicably coupled to the frequency scanning radio receiver.

42. The method as recited in claim 41 further comprising the step of communicating between the local device and the frequency scanning radio receiver via infrared communication.

43. The method as recited in claim 41 further comprising the step of communicating between the local device and the frequency scanning radio receiver via short range radio communication.

44. The method as recited in claim 41 further comprising the step of communicating between the local device and the frequency scanning radio receiver via a data cable.

45. The method as recited in claim 38 the step of maintaining a non remote database of frequency data of a plurality of transmitting parties further comprises maintaining the non remote database of frequency data relating to at least one usage type.

46. The method as recited in claim 38 wherein the step of identifying the location of the frequency scanning radio receiver further comprises identifying the location of the frequency scanning radio receiver using an internal GPS based position locator circuit.

47. The method as recited in claim 38 wherein the step of identifying the location of the frequency scanning radio receiver further comprises identifying the location of the frequency scanning radio receiver using a local GPS based position locating device.

48. The method as recited in claim 38 wherein the step of identifying the location of the frequency scanning radio receiver further comprises identifying the location of the frequency scanning radio receiver using an internal cellular network based position locator circuit.

49. The method as recited in claim 38 wherein the step of identifying the location of the frequency scanning radio receiver further comprises identifying the location of the frequency scanning radio receiver using a local cellular network based position locating device.

50. The method as recited in claim 38 wherein the step of identifying the location of the receiver further comprises identifying the location of the receiver using an input device.

51. The method as recited in claim 38 further comprising displaying identification data corresponding to the transmitting party of interest when receiving a transmission therefrom.

52. A method for dynamically programming a frequency scanning radio receiver to monitor frequencies of transmitting parties of interest comprising the steps of:
maintaining a non remote database of frequency data including operating frequencies and geographic locations of a plurality of transmitting parties;
identifying the location of the frequency scanning radio receiver;
compiling frequency data for the transmitting parties of interest selected from the plurality of transmitting parties based upon the location of the frequency scanning radio receiver;
programming the frequency scanning radio receiver to monitor transmissions at the frequencies of the transmitting parties of interest;
moving the frequency scanning radio receiver to a different location having different transmitting parties of interest; and
dynamically reprogramming the frequency scanning radio receiver to monitor transmissions at the frequencies of the different transmitting parties of interest by identifying the different location of the frequency scanning radio receiver and compiling frequency data for the different transmitting parties of interest selected from the plurality of transmitting parties based upon the different location of the frequency scanning radio receiver.
